(19) United States
(12) Patent Application Publication
(10) Pub. No.: US 2026/0029506 A1
(43) Pub. Date: Jan. 29, 2026

(54) Best Sensor/Measurement Selection for Locating RFID Tags

(71) Applicant: Automaton, Inc., San Diego, CA (US)

(72) Inventors: Stewart Webb, Anaheim Hills, CA (US); Melissa Swats, Boca Raton, FL (US); Joe Mueller, San Diego, CA (US); Paul Petrus, San Jose, CA (US)

(73) Assignee: Automaton, Inc., San Diego, CA (US)

(21) Appl. No.: 19/329,820

(22) Filed: Sep. 16, 2025

Related U.S. Application Data
(63) Continuation of application No. PCT/US2024/020353, filed on Mar. 18, 2024.
(60) Provisional application No. 63/490,834, filed on Mar. 17, 2023.

(51) Int. Cl. G01S 5/04; G01S 5/02; G01S 5/06; G06K 7/10

(52) U.S. Cl. CPC G01S 5/04; G01S 5/0244; G01S 5/0247; G01S 5/0278; G01S 5/06; G06K 7/10415

(57) ABSTRACT

Radio-frequency identification (RFID) systems use readers to query and locate passive RFID tags in stores, warehouses, and other environments. A signal from the reader powers up the tag, which modulates and backscatters the signal toward the reader. The reader or an appliance coupled to the reader can estimate the tag's position based on the angle of arrival (AOA) of the backscattered signal. In some situations, AOA measurements by different readers may yield different position estimates for the same tag. If these position estimates are close enough to each other (e.g., within the expected imprecision or error radius), they can be averaged to improve precision. If not, the appliance can measure the variance or another measure of dispersion for each reader's position estimates, then pick the reader with the lowest dispersion as the preferred or best sensor for locating that tag, improving precision and reducing processing time.

### CROSS REFERENCE TO RELATED APPLICATION(S)

This application is a bypass continuation of International Application No. PCT/US2024/020353, filed on Mar. 18, 2024, which claims the priority benefit, under 35 U.S.C. 119(e), of U.S. Application No. 63/490,834, filed on Mar. 17, 2023, which is incorporated herein by reference in its entirety for all purposes.

### BACKGROUND

Radio-frequency identification (RFID) tags, or tags, are low-cost devices that can be attached to objects and offer the promise of automated tracking, locating, sales check-out, and inventory of the objects among other commercial, industrial, and medical applications. There are passive, semi-active, and active types of RFID tags that can be wirelessly interrogated by an RFID tag reader, also called a reader or sensor, and emit wireless RF replies to the reader. Each reply can include information stored in the RFID tag, such as a tag identification number, an electronic product code (EPC), or other unique alpha-numeric sequence or identifier. Other information may be included with the reply.

Passive RFID tags have no battery and are therefore typically less expensive than semi-active and active RFID tags. A passive RFID tag is powered by an unmodulated, continuous-wave RF signal from the RFID tag reader. This continuous-wave RF signal powers up the passive RFID tag's circuitry and precedes a query or command from the RFID tag reader in the form of a modulated RF signal. The passive RFID tag receives and demodulates the modulated RF signal and responds to the RFID tag reader by modulating and backscattering a portion of the modulated RF signal. This modulated, backscattered RF signal is the passive RFID tag's reply to the query or command and is detected by the RFID tag reader. The replies from passive RFID tags are typically many orders of magnitude weaker than the RF signals from the RFID tag readers. This makes the replies more difficult to detect at longer ranges and limits the range of passive RFID tags.

Each cycle of transmitting a continuous-wave (cw) RF signal and a query or command to the tag and receiving the tag's reply is called a hop. The cw RF signal and query or command for each hop can be at a different carrier frequency, i.e., a sensor can hop among carrier frequencies within a particular frequency band as it interrogates different tags. Many tags can respond during a single hop, but the FCC regulates the maximum duration of a hop, so a sensor can repeat hops periodically until it has read all of the tags within range if the tag population is too large to be read within a single hop. The sensor can continue to query the tags within range periodically, for example, to monitor inventory of the items the tags are attached to.

The sensors can be used to estimate the tag's location in three dimensions using one of several techniques. For instance, each sensor may detect the amplitude or power of the tag's reply in addition to the unique modulation (e.g., the EPC) that identifies which tag is replying to the query. In other words, each sensor can record a received signal strength indicator (RSSI) for each tag within range. If the sensor has an antenna array that can sense the angle-of-arrival (AOA) of the tag's reply, the sensor can record the AOA in addition to or instead of the RSSI. A computer coupled to the sensors can use the measured RSSIs and/or AOAs to estimate the tag's position.

### SUMMARY

In practice, attenuation, dispersion, multipath propagation, manual errors in the locations of the sensors, and other effects can cause a sensor or group of sensors to identify more than one possible position or location for a given RFID tag. In some cases, the position estimates are within an accepted margin of error of each other and can be averaged to improve location accuracy. In other cases, however, the position estimates are far enough apart to be considered distinct. In these, it may not be possible to determine which position estimate is correct without some additional information about the tag, the sensor(s), or the environment.

Fortunately, an RFID system can derive this additional information from the replies themselves as well as from other a priori knowledge to select a preferred or best sensor or set of sensors for estimating the position of each RFID tag in the environment. The RFID system can pick a different sensor or set of sensors for each RFID tag based purely on metrics derived from the detected replies.

Selecting a best sensor or set of sensors for estimating the position of each RFID tag in the environment has a number of benefits. First, it increases the likelihood of accurately estimating the RFID tag's position. Second, it reduces the time and processing power used to estimate the RFID tag's position, for example, by reducing the number of sensors that interrogate a given RFID tag and/or by reducing the number of sensor measurements that are processed to locate each RFID tag.

The “best sensor” techniques disclosed here can be implemented as method of locating an RFID tag with first, second, and/or more RFID tag readers. The first and second RFID tag readers detect first and second replies, respectively from a given RFID tag. The first and second RFID tag readers or an appliance coupled to the first and second RFID tag readers determines first and second sets of possible positions of the RFID tag based on the first and second replies, respectively. The appliance also determines measures of dispersion of the first and second sets of possible positions and selects, based at least in part on the measures of dispersion, the first or second set of possible positions, then estimates the position of the RFID tag based on the selected set of possible positions, e.g., by averaging the selected set of possible positions.

The appliance (or first RFID tag reader) can determine the first set of possible positions by determining respective angles of arrival (AOAs) at the first RFID tag reader for the first replies and estimating the first set of possible positions of the RFID tag based on the respective AOAs. To do this, the appliance or first RFID tag reader can filter out spurious or suspicious AOAs, e.g., based on elevation angle and/or distance between the RFID tag and the first RFID tag reader.

The measures of dispersion can include a variance, a standard deviation, or a hypotenuse of a triangle defined by maximum x and y coordinates and minimum x and y coordinates among the possible positions in the first set of possible positions. The appliance may select the first or second set of possible positions with the lower measure of dispersion for estimating the location of the RFID tag.

Another method of locating RFID tags includes detecting replies from each of a plurality of RFID tags at each of a plurality of RFID tag readers. Each RFID tag reader detects replies from each RFID tag. For each RFID tag/RFID tag reader combination, the RFID tag reader or an appliance coupled to the RFID tag reader estimates a set of position estimates for that RFID tag based on the replies detected from that RFID tag by that RFID tag reader. The appliance determines respective measures of dispersion for the sets of position estimates for that RFID tag and selects, based on the measures of dispersion, one of the RFID tag readers as a preferred RFID tag reader for that RFID tag. The appliance then estimates the location of that RFID tag based only on replies detected by the preferred RFID tag reader for that RFID tag.

If the appliance detects a change in the measure of dispersion of the set of position estimates from the preferred RFID tag reader for a particular RFID tag, it can update which RFID tag reader is the preferred RFID tag reader for that RFID tag in response to the change. For example, it can select a different RFID tag reader in the plurality of RFID tag readers as the preferred RFID tag reader if that RFID tag reader has a lower measure of dispersion among its position estimates for that RFID tag. Or it can select the same RFID tag reader as the preferred RFID tag reader, e.g., if the same RFID tag reader still has the lowest measure of dispersion among its position estimates for that RFID tag.

Another method of locating an RFID tag includes detecting replies from the RFID tag at first and second RFID tag readers, respectively; determining, based on the first and second replies, respective first and second sets of possible positions of the RFID tag; performing a correlation of the possible positions in the first and second sets of possible positions; and estimating a location of the RFID tag based on the correlation.

All combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. The terminology explicitly employed herein that also may appear in any disclosure incorporated by reference should be accorded a meaning most consistent with the particular concepts disclosed herein.

### BRIEF DESCRIPTIONS OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar components).

FIG. 1A depicts an environment, such as a store or warehouse, with several ceiling-mounted RFID tag readers and RFID tags.

FIG. 1B illustrates an RFID tag reader suitable for use in the RFID environment of FIG. 1A.

FIG. 1C illustrates an appliance suitable for controlling RFID tag readers in the RFID environment of FIG. 1A.

FIG. 2A illustrates a process for estimating the position of an RFID tag using replies from that RFID tag detected by a single RFID tag reader.

FIG. 2B illustrates a process for estimating the position of an RFID tag using replies from that RFID tag detected by several RFID tag readers.

FIG. 3 illustrates a state machine representation of an RFID tag location system that select the best position estimate(s) for an RFID tag from among position estimates derived from tag replies detected by multiple RFID tag readers.

FIG. 4 illustrates a process for estimating the locations of different RFID tags from replies collected by different RFID tag readers in an RFID tag location system.

FIG. 5 illustrates a process for estimating the locations of different RFID tags from replies collected by different RFID tag readers in an RFID tag location system.

FIG. 6 is a polar plot of a single RFID tag reader's position estimates for a single RFID tag with the RFID tag reader at the origin.

FIG. 7 is a plot in Cartesian coordinates of modal location estimates for a single RFID tag from two RFID tag readers, ab and cd.

FIG. 8 is a plot in Cartesian coordinates of location estimates for different RFID tags 1-5, including modal location estimates for RFID tag 1.

### DETAILED DESCRIPTION

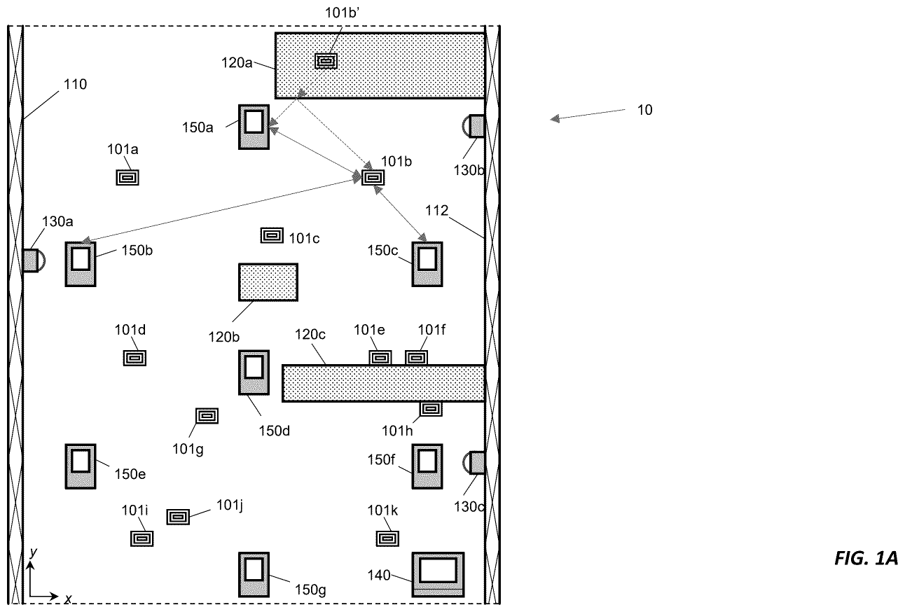

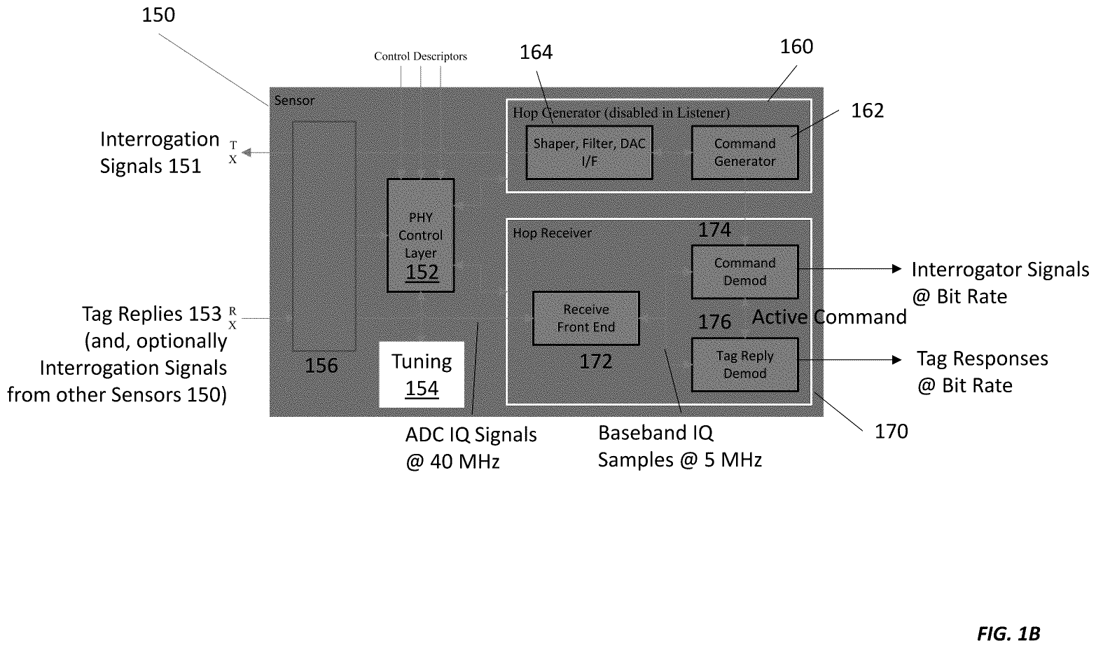

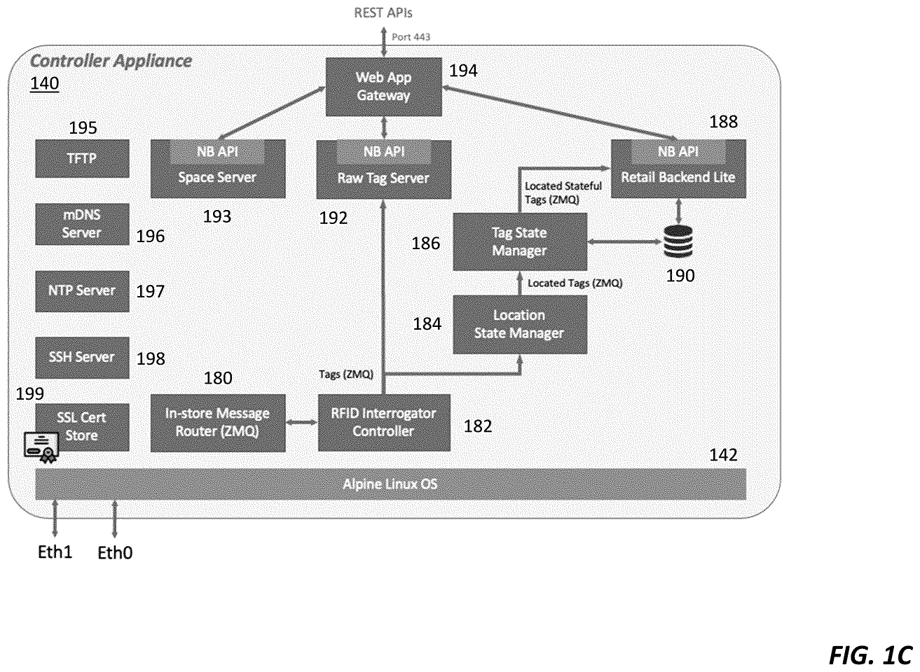

FIG. 1A depicts an environment 10 with a dense population of passive RFID tags 101a-101k (collectively, passive RFID tags 101, or simply RFID tags or tags), and an RFID tag location system that includes several RFID tag readers 150a-150g (collectively, RFID tag readers 150), also called readers or sensors; an appliance 140, also called a central controller or interrogator controller; and optional cameras 130a-130c (collectively, cameras 130). The RFID tag readers 150 communicate with and track the locations of the RFID tags 101, which are attached to objects (not shown) in the environment 10. These objects may be items for sale, such as articles of clothing; fixtures or furnishings, such as tables, shelves, walls, or doors; or people, such as employees, customers, or other visitors. The RFID environment 10 can be in a retail store or warehouse, for example, though other settings are possible.

There can be furnishings 120a-120c (collectively, furnishings 120) in the environment 10 that block, attenuate, and/or scatter RF signals transmitted by the RFID tag readers 150 and the passive RFID tags 101. These furnishings 120 can include shelves, racks, cabinets, etc. that may be used to hold the objects to which at least some of the RFID tags 101 are attached. (There may also be RFID tags 101 on at least some of these furnishings 120, for example, reference RFID tags 101 whose locations are known and can be used to locate RFID tags 101 at unknown locations.)

For example, some furnishings 120 may comprise metal shelving that holds one or more items for sale (not shown in FIG. 1A) that are tagged with the RFID tags 101. The furnishings 120 can be arranged in rows in some settings, with aisles separating the rows to allow access to all objects tagged with RFID tags 101. The RFID environment 10 can be bounded by walls 110 and 112, a ceiling, and a floor, any of which can reflect or scatter RF signals from the RFID tag readers 150 and/or RFID tags 101.

The RFID tag readers 150 are preferably installed in the RFID environment 10 such that every RFID tag 101 in the environment can communicate with at least one of the RFID tag readers 150. In a typical installation, the RFID tag readers 150 are mounted to or suspended from the ceiling. If the ceiling is a drop ceiling or secondary ceiling, the RFID tag readers 150 can be hung from the ceiling panels, mounted to the ceiling panels, or placed between the ceiling panels and the structural ceiling, e.g., as in International Application No. PCT/US2022/081761, entitled “Antenna Arrays and Signal Processing for RFID Tag Readers” and filed on Dec. 16, 2022, which is incorporated herein by reference in its entirety for all purposes. In addition, or instead, one or more of the RFID tag readers 150 can be mounted to the walls 110 or 112 or fixed furnishings 120.

There may be one or more cameras 130a-130c (collectively, cameras 130) installed in the environment 10 to capture images of at least portions of the environment 10 and of people and objects within the environment 10. The cameras 130 can be communicatively coupled to the appliance 140, which can receive and process images from the cameras 130 and data from the RFID tag readers 150. If desired, the appliance 140 can use the images from the cameras 130 and the data from the RFID tag readers 150 to locate the RFID tags 101 and associate them with people and/or objects in the environment 10. The appliance 140 can also determine a route from a person's location to a particular RFID tag 101/object, for example, if the person is looking for the object or the object should be moved from its current location. The appliance 140 can recognize the person from the image or from an RFID tag 101, smartphone, or other wireless device carried by the person and can trigger a sale of the object or other inventory change based on the person's movements with the object.

The RFID tag readers 150 may communicate with each other and/or with the appliance 140 via wireless or wired (e.g., Ethernet) connections. The appliance 140 may be a specialized device with a processor, memory, power supply, and network interface(s) or a suitably programmed computer, laptop, or smart phone adapted to communicate with the RFID tag readers 150 and issue commands recognizable to the RFID tag readers 150. The appliance 140 can also receive signals from the RFID tag readers 150. For example, the appliance 140 can command the RFID tag readers 150 to inventory all RFID tags 101 (and attached items) in the environment 10 or to determine the location of one or more RFID tags 101 (and attached item(s)) in the environment 10. The appliance 140 can also command the RFID tag readers 150 to query the RFID tags 101 according to a schedule.

While one RFID tag reader 150 is interrogating an RFID tag 101, one or more of the other RFID tag readers 150 within range can listen for the RFID tag's reply. In other words, each RFID tag reader 150 can transmit a signal to a tag in turn, and all of the RFID tag readers 150 listen for each of the tag's responses. In this arrangement, the tag reader 150 that transmits a query or command is called an interrogator, and the other tag readers 150 are called listeners. The tag readers 150 can alternate turns/hops as interrogators and listeners. For more on schedules, interrogators, and listeners, please see International Application No. PCT/US2022/026198, entitled “RFID Tag Readers Switchable between Interrogator and Listener Modes,” which is incorporated herein by reference in its entirety for all purposes. The RFID tag readers 150 can send raw or processed data representing the RFID tags' replies to the appliance 140, which uses this data to identify and/or locate the RFID tags 101 and/or attached objects.

Each RFID tag reader 150 includes an antenna array, such as a four-element square antenna array, which transmits signals to the RFID tags 101 and receives replies from the RFID tags 101. These signals and replies may experience attenuation, interference, scattering, and/or other effects as they propagate along pathways, or communication channels, between the RFID tag reader 150 and the RFID tags 101. These effects may vary over time, e.g., as people and objects move about the environment 10. If the attenuation in a communication channel between a particular RFID reader 150 and a particular RFID tag 101 is too high, or if a furnishing 120, person, or object blocks the pathway between them, then that RFID tag reader 150 may not be able to communicate with that RFID tag 101.

In some cases, several RFID tag readers 150 can detect replies from the same RFID tag 101. In the environment of FIG. 1A, for example, RFID tag readers 150a-150c may all be able to detect replies from RFID tag 101b via line-of-sight (LOS) paths indicated by solid, double-headed arrows in FIG. 1A. If each RFID tag reader 150a-150c measures the RSSIs and/or angles of arrival (AOAs) of the replies along the LOS paths, then those RSSIs and/or AOAs can be used to estimate the tag's location.

Ideally, the replies from RFID tag 101a detected by RFID tag readers 150a-150c should indicate or correspond to the same location for RFID tag 101b. In practice, however, differences in the communication channels between RFID tag 101b and RFID tag readers 150a-150c or differences among RFID tag readers 150a-150c themselves can cause the replies from RFID tag 101b detected by RFID tag readers 150a-150c to appear to come from different locations. If these estimated locations are all centered about the actual location of RFID tag 101b, then they can be averaged to yield a more precise estimated location. But if one of the estimated locations deviates significantly from both the actual location and the other estimated locations, it can skew the average, degrading accuracy of the RFID tag location estimates provided by the RFID tag location system.

For example, one or more of the communication channels between the readers 150 and tags 101 may be multipath communication channels, where signals travel along non-line-of-sight (NLOS) paths in addition to or instead of along LOS paths. Replies propagating along NLOS paths may reflect or scatter off walls 112, fixtures 120, and other objects in the environment 10. For example, the dashed, double-headed arrow in FIG. 1A shows an NLOS path between RFID tag reader 150a and RFID tag 101b with reflection or scattering off fixture 120a. The AOA of the reply that the RFID tag reader 150a receives along this NLOS path extrapolates to a spurious position estimate 101b′ for the RFID tag 101b. As a result, the RFID tag reader 150a may return an incorrect position estimate (e.g., an average of the true/correct and spurious position estimates 101b, 101b′) or, if the position estimates are from different attempts to read the tag 101, both the correct or true position estimate for the RFID tag 101b and the spurious position estimate 101b′ for the RFID tag 101b. Without more information, it may be impossible to determine which of the position estimates is (more likely to be) correct, and averaging the estimates will not improve accuracy.

In this example, the spurious position estimate 101b′ is caused by the multipath communication channel between the RFID tag reader 150a and the RFID tag 101b. Other effects can also produce spurious position estimates for each communication channel, including detection of scattered signals, including the interrogation signal; aliasing at the sensor; and self-interference at the sensor. Without additional information, it can be impossible to resolve the true position estimate from the spurious position estimates.

Fortunately, noise or variance in position estimates, measurements by other RFID tag readers 150, position estimates for tags with similar EPCs, and/or a priori knowledge about the tag, tag reader(s), and/or environment 10 can be used to determine which position estimates are more likely to be correct. This additional information can be used to select a preferred or best sensor 150 or set of sensors 150 for estimating the location of each RFID tag 101 in the environment. In FIG. 1A, for example, AOA measurements by the RFID tag readers 150b and 150c produce location estimates that coincide with one of the two location estimates from RFID tag reader 150a (i.e., at the true location of the tag 101b). The appliance 140 can use this coincidence to discard one or both position estimates generated from the measurements by sensor 150a and to designate sensors 150b and 150b as the best or preferred sensors for estimating the location of tag 101b.

The two location estimates from reader 150a form modal groups—they are of the same tag, as indicated by the EPC encoded in the replies, but at very different azimuths. More generally, modal clusters are clusters of position estimates from one sensor for a given tag (EPC) where the elevations may be similar but the azimuths are wildly different (e.g., 120-180 degrees apart). Averaging the AOA measurements or position estimates in different modal clusters usually will not produce a realistic estimate (e.g., the average could be under the sensor). In practice, modal behavior tends to be relatively rare.

Without being bound to any particular theory, modal cluster could be due to grating lobes in the antenna array. As described below, a reader can locate a tag using a channel estimate that characterizes the communications channel between the reader and the tag at a particular carrier frequency. The reader or interrogator controller coupled to the reader uses the channel estimate and corresponding carrier frequency to determine the AOA measurements by selecting peak values from an array manifold. In multimodal (e.g., bimodal) cases, there are two (or more) peaks of similar magnitude in the array manifold. Picking one peak versus another can result in very different elevation and azimuth values for the AOA measurement for that tag/reader pair.

### RFID Tag Reader Architecture

FIG. 1B illustrates a reader 150 in greater detail, including components that can be enabled or disabled if the reader 150 is in interrogator mode or listener mode. The reader 150 includes an RF antenna array and front end 156, a processor 152, an RF calibration and tuning block 154, a hop generator 160, and a hop receiver 170. The RF antenna array and front end 156 may include one or more antenna elements (e.g., arranged in a multi-element antenna array), amplifiers, filters, and/or other analog RF components for transmitting RFID interrogation signals 151 and receiving tag replies 153 and, optionally, RFID interrogation signals from other readers. The processor 152 may be implemented in a microcontroller, application-specific integrated circuit (ASIC), field-programmable gate array (FPGA), or other suitable device and controls the operation of the reader 150, including, if desired, steering of the reader's antenna array. It stores information in and retrieves information from a memory (not shown) and communicates with the appliance 140 via a network connection (not shown), such as an Ethernet connection. If the reader 150 is configured to operate in interrogator and listener modes, the processor 152 switches the reader 150 between interrogator and listener modes, with the hop generator 160 being disabled or off in listener mode and enabled or on in interrogator mode and the hop receiver 170 being enabled or on in both modes. The RF calibration and tuning block 154 performs RF calibration and tuning functions.

The hop generator 160 generates the interrogation signals 151 that the reader 150 transmits to the RFID tags 101. The hop generator 160 can optionally also generate commands or communications signals intended for other readers 150, e.g., on a dedicated reader communications channel or with particular preambles or payloads. It includes a digital command generator 162, which generates the digital queries, commands, and/or other information conveyed by the interrogation signals 151, and RF electronics 164 for turning the digital signals from the command generator 162 into analog signals suitable for transmission by the antenna array in the front end 156. The RF electronics 164 may include a digital-to-analog converter (DAC) that converts the digital signal into a baseband analog signal, a mixer and local oscillator to mix the baseband analog signal up to an intermediate frequency for broadcast, and filters and/or pulse shapers to remove sidebands and/or spurs.

The hop receiver 170 includes a receiver front end 172 coupled to a command demodulator 174 and a tag reply demodulator 176. Generally, the receiver front end 172 digitizes, downconverts, and estimates the phase of the RF signals detected by the antenna(s). There are a variety of ways to configure the receiver front end 172; in this example, it receives analog in-phase and quadrature (I/Q) signals at higher frequency (e.g., 40 MHz) and converts them into digital I/Q samples at baseband (e.g., 5 MHz).

In interrogator mode, the front end 172 also cancels any self-interference caused by the interrogation signals 151, for example, due to leakage within the receiver. Fortunately, the receiver front end 172 generally can cancel crosstalk between different antenna elements and the circuits coupled to those antenna elements because the crosstalk is correlated with the interrogation signal 151. This crosstalk can be further reduced or suppressed by spacing the antenna elements farther apart from each other as explained in International Application No. PCT/US2022/081761, filed on Dec. 16, 2022, which is incorporated herein by reference in its entirety for all purposes.

When the reader 150 is in listener mode, it does not transmit an interrogation signal, nor does it perform self-interference cancellation. In listener mode, the reader 150 detects the channels on which the other readers 150 transmit interrogation signals 151 and estimates the frequencies of those other interrogation signals 151.

The command demodulator 174 is enabled when the reader 150 is in listener mode and demodulates commands from other readers to reproduce the interrogator's signals at the command bit rate (e.g., 40 kbps to 160 kbps). The command demodulator 174 uses the command payload to determine what the reader in interrogator mode is asking of the tag 130 (e.g., modulation, preamble type, expected reply type, etc.). For example, the reader 150 in interrogator mode may ask the tag 130 to send the first 64 bits of its EPC using Miller-2 modulation at 320 kHz backscatter link frequency (BLF) with the standard preamble. The readers 150 in listener mode use that information to decode the tag reply 153. The command demodulator 174 is disabled when the reader 120 is in interrogator mode.

The tag reply demodulator 176 is enabled in both interrogator and listener modes and demodulates the baseband tag reply I/Q samples to produce tag reply signals at the tag reply bit rate.

### Appliance Architecture

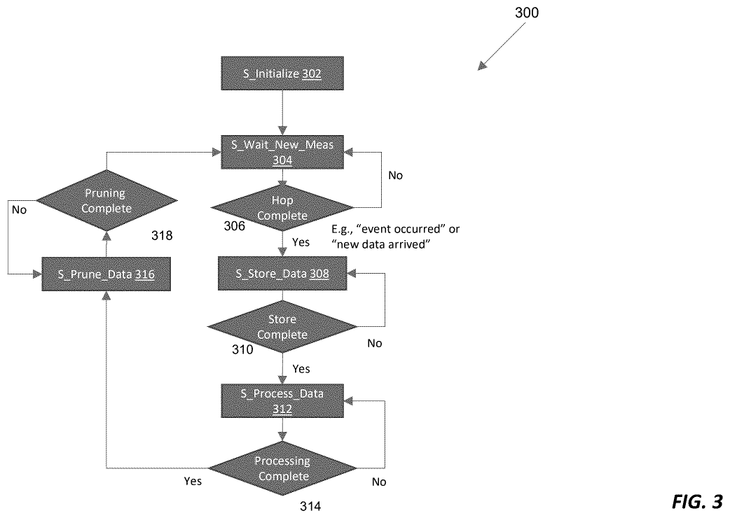

FIG. 1C shows the appliance 140 in greater detail in FIG. 3B. The controller appliance 140 can include one or more processors, non-volatile memories, and other logic devices implemented as integrated circuits and powered by appropriate power supplies and other housekeeping electronics. These processors and logic devices may include discrete components that perform discrete functions and/or more general-purpose components that are programmed to perform a variety of functions, either by themselves or in concert with other components of the controller appliance 140. For instance, the controller appliance 140 may include a central processor unit (CPU) 142 running an operating system (e.g., Alpine Linux OS) that manages the controller appliance's hardware and software resources, including communications interfaces, shown as Ethernet connections Eth0 and Eth1, connected to the readers 150, the POS system, and/or other devices. The controller appliance's non-volatile memory can store the operating system and other firmware and software as well as tag state information.

FIG. 1C illustrates the appliance 140 as a block diagram, where each block represents a different function or sub-function performed by the appliance 140. To monitor and update tag states, the controller appliance 320 includes or implements an in-store message router 180, RFID interrogator controller (RFID-IC) 182, location state manager 184, tag state manager 186, and retail backend application programming interface (API) 188. The in-store message router 180 queues and routes messages exchanged between the readers 150 and RFID-IC 182 via the Ethernet connections Eth0 and Eth1. The RFID-IC 182 employs a split media access controller (MAC) design to handle messages exchanged with the readers 150, with a lower MAC layer implemented in the readers 150 and an upper MAC layer implemented in the RFID-IC 182. The lower MAC layer determines a timestamp and parameters, estimated from the RFID tag's backscattered response, useful for determining the tag's position. The upper MAC layer schedules hop transmissions and the general purpose of each hop. The lower MAC layer executes more time-critical functions, such as actually scheduling when to transmit commands and how to react to replies within a hop. A positioning layer comprising the RFID-IC and/or the reader(s) 150 calculates the RFID tag's position in a 3D coordinate system (e.g., Cartesian coordinates with an origin at a known location in the store or room) from data coming from the MAC and PHY layers. The messages from the reader 150 may also include data read from the RFID tag, including the RFID tag's EPC and other metadata.

The location state manager 184 and tag state manager 182 track the RFID tag's location and state, respectively. The location state manager 184 receives the RFID tag's estimated location from the RFID-IC 182 (e.g., in a Cartesian coordinate frame with the origin at one corner of the store) and determines where (e.g., the room and zone) in the RFID environment in which the RFID tag is located. The rooms and zones may be extracted from a 3D model of the store or space. In a retail RFID environment, the rooms and zones can include a receiving area, stockroom, sales floor, and changing room, with the sales floor further divided into an entrance/exit zone and a checkout zone. The location state manager 184 updates each RFID tag's location in an inventory database 190, which may be hosted locally or off site (e.g., in the cloud), based on changes in location detected by the reader(s) 150.

The tag state manager 186 manages the tag's state, including its location and availability. There are several possible availability states, including but not limited to: (1) available; (2) stale (optional); (3) ignored; (4) missing; and/or (5) sold. There may be other states as well. The tag state manager 186 transitions the RFID tags 101 among these states based on the tags' responses (or lack of responses) to queries from the readers 150, including information about the tags' locations, and on the tag states stored in the inventory database 190. For more on tag states and stateful inventory management, please see International Application No. PCT/US2023/061645, filed on Jan. 31, 2023, which is incorporated herein by reference in its entirety.

The tag state manager 186 updates the tag states stored in the inventory database 190 and forwards both the tag state and tag location estimate to the retail backend lite API 188, which implements the backend functions for inventory, restocking, and product lookup. The retail backend lite API 188 can implement these functions via a web app gateway 194, which implements a Hypertext Transfer Protocol (HTTP) proxy, redirecting Representational State Transfer (REST) requests to the appropriate backend server (not shown). The web app gateway 194 can also provide user authentication and authorization and serves the static files used by browsers to render web pages.

FIG. 1C also shows several optional components of the appliance 140, including a raw tag server 192, space server 193, Trivial File Transfer Protocol (TFTP) server 195, multicast Domain Name Service (mDNS) server 196, Network Time Protocol (NTP) server 197, Secure Shell (SSH) server 198, and Secure Sockets Layer (SSL) certificate store 199. The space server 193 handles firmware lifecycle management and configuration of the sensors 150 and Power-over-Ethernet (PoE++) switches (not shown) that connect the appliance 140 to the sensors 150. The raw tag server 192 retrieves tag metadata for legacy APIs, such as those used by API clients for system debugging. When they boot, the sensors 150 download executable images from the TFTP Server 195. The mDNS server 196 enables the appliance 140 to advertise itself using the mDNS and DNS-SD protocols, e.g., for during debugging. The NTP server 197 connects and synchronizes with a remote (e.g., Internet-based) NTP server and provides NTP service to the sensors 150. The SSH server 198 is also used for debugging. And the SSL certificate store 199 hosts the server certificates used by the sensors 150 and the web-server certificate used by the REST clients to authenticate the appliance 140.

### Estimating the Position of an RFID Tag

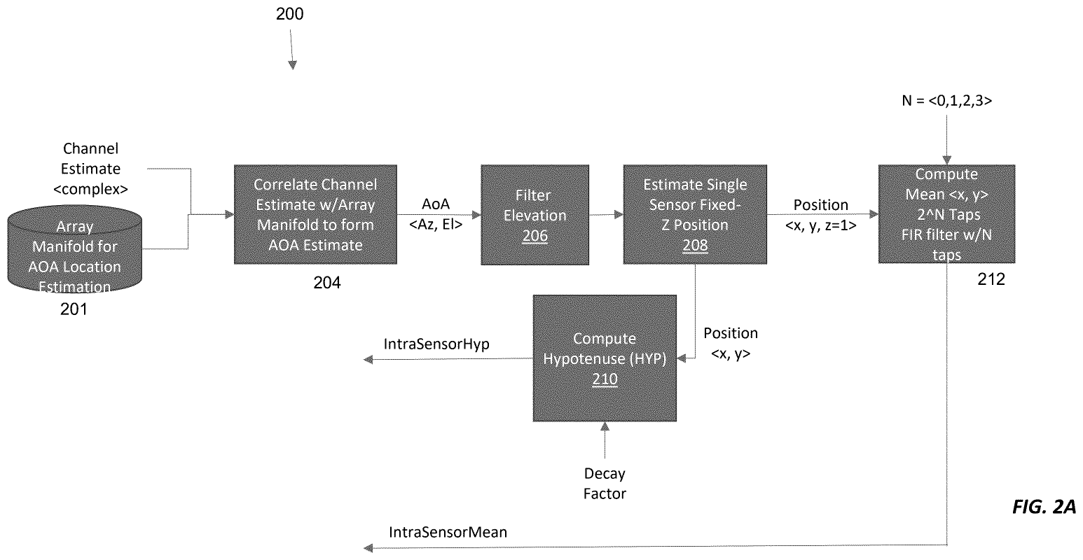

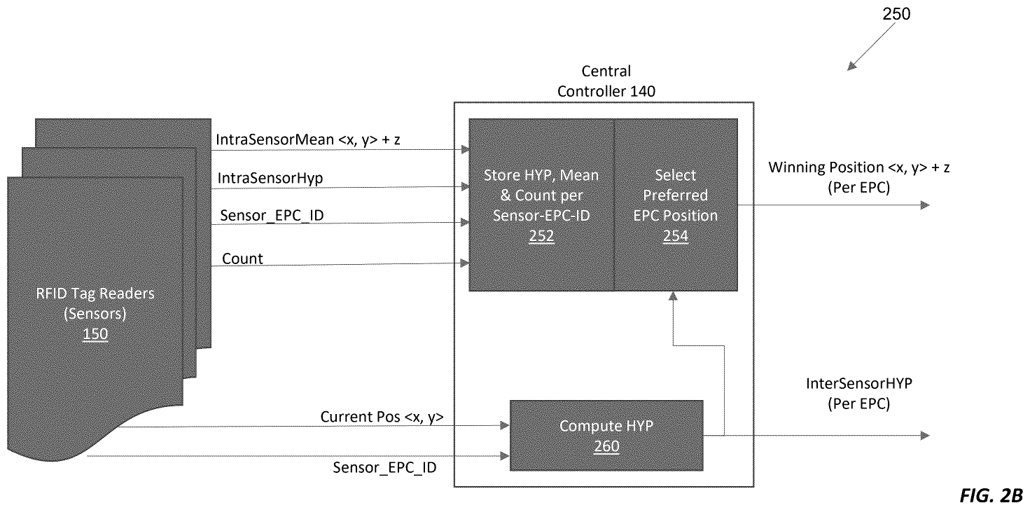

FIGS. 2A and 2B illustrate how to estimate the position of an RFID tag (e.g., RFID tag 101a in FIG. 1A) using replies from that RFID tag detected by multiple RFID tag readers (e.g., RFID tag readers 150a-150b). Position estimation can be carried out by each tag reader, by the appliance, or by the tag readers and the appliance together. The appliance typically has more processing power than the embedded devices (tag readers) but offloading processing onto the tag readers can make it easier to scale the system (e.g., by reducing the processing per tag reader performed by the appliance, the appliance can handle more tag readers) and frees up the appliance for other tasks. Generally, the appliance performs processes that use data acquired by multiple tag readers (e.g., triangulation) because an individual tag reader may not have data from other tag readers.

FIG. 2A shows a process 200 for estimating the position of the RFID tag using replies from that RFID tag detected by a single RFID tag reader (e.g., RFID tag reader 150a). The RFID tag reader's antenna array can be characterized by an array manifold 202, which is a hypersurface that describes the antenna array's response to incident radio waves—in this case, the replies from the RFID tag. The array manifold 202 is correlated (204) with a complex channel estimate of the communication channel between the RFID tag and the RFID tag reader to form an estimate of the AOA of the replies at the RFID tag reader.

The AOA estimate can include estimates of both the azimuth and elevation angles with respect to the sensor. For an RFID tag reader mounted from the ceiling and pointing down, an elevation angle of 180 degrees corresponds to boresight, i.e., straight down from the ceiling to the floor. An elevation angle of 90 degrees is level with the ceiling. Since RFID tags are unlikely to be close to the ceiling, AOA estimates with elevation angles below a threshold (e.g., 110 degrees) can be filtered out or removed (206) as unrealistic using a digital sieve-type filter or other suitable filter. Once the AOA estimates have been filtered, they can be used to estimate (208) the RFID tag's position in Cartesian coordinates assuming that the RFID is at a particular height from the floor or vertical distance below the RFID tag reader (i.e., a fixed position in z, such as 1 meter above the floor). If the RFID tag reader receives many replies from the RFID tag, it can estimate an AOA and a position for each reply, then compute the mean position estimate (212), for example, using a finite impulse response (FIR) filter with N taps chosen based on the desired filter performance. The mean position estimate for a single RFID tag reader is called the intra-sensor mean position estimate (IntraSensorMean).

The system also computes a measure of the dispersion, or spread, of the distribution the position estimates derived from the RFID tag reader's AOA measurements (210). Dispersion of the position estimates can be caused by noise in the replies detected by the sensors. It can be characterized by the variance or standard deviation of the position estimates. Another measure of dispersion is the hypotenuse of the triangle defined by the distance between the maximum x and y coordinates and minimum x and y coordinates:

$$HYP = \sqrt{{( {x}_{max} - {x}_{min} )}^{2} - {( {y}_{max} - {y}_{min} )}^{2}} . \qquad ( 1 )$$

Because the hypotenuse is based on dispersion in two dimensions (e.g., within a plane at a height z=1 meter), it is especially useful for evaluating position estimates from a single sensor. (Alternatively, the hypotenuse can be of a triangular pyramid defined by the maximum x, y, and z coordinates and minimum x, y, and z coordinates and provide a measure of dispersion in three dimensions.) The hypotenuse is a sensitive measure of the dispersion or spread among a set of position estimates and can be calculated quickly from as few as two measurements. The hypotenuse for a single RFID tag reader is called the intra-sensor hypotenuse (IntraSensorHyp).

The system may weight the position estimates when selecting the maximum and minimum x and y coordinates based on the position estimates' ages or a decay factor, such as an exponential decay factor or step function. It can also discard position estimates after a certain period (e.g., 1 hour, 6 hours, 12 hours, 1 day, or more) or as it accumulates more position estimates (e.g., 10, 25, 50, 100, or more position estimates). For instance, the readers and/or interrogator controller can discard position estimates at a rate proportional to the tag read rate, which can vary with tag population. The readers and/or interrogator controller can also average a number of consecutive position estimates (e.g., the last 10 position estimates) or the position estimates acquired over a fixed period of time (e.g., the last 5, 10, 15, 30, or 60 minutes). Similarly, the mean and the hypotenuse or other measure of dispersion can be recomputed periodically as older position estimates are faded or discarded and replaced by newer position estimates. Fading or discarding the x and y position estimates over time prevents an inaccurate initial reading from bounding or skewing the hypotenuse.

FIG. 2B illustrates how position estimates for the same RFID tag from multiple RFID tag readers 150 can be used to produce a preferred position estimate for that RFID tag. Each RFID tag reader 150 within range detects multiple replies from the RFID tag and computes multiple position estimates for the tag at a fixed height (z) (e.g., one position estimate for each detected reply), an intra-sensor mean position estimate at the fixed height, and an intra-sensor hypotenuse. For instance, an RFID tag reader 150 can compute an intra-sensor mean from two or more position estimates (e.g., 10, 100, or 1000 position estimates). If only one position estimate is available, then the sensor 150 can report that position estimate, even though its noise properties may be worse than a mean position estimate. The RFID tag readers 150 supply these means and hypotenuses to the appliance 140 along with the EPC for the RFID tag (Sensor_EPC_ID) and the number of detected replies, or count, from the RFID tag. (The EPC is contained in each reply and uniquely identifies the RFID tag that sent the reply as well as the item that the RFID tag is attached to.) The appliance 140 stores this information in its memory (252) and uses it to select the preferred or winning position for the RFID tag (254) as described below.

The appliance 140 also receives each RFID tag reader's current or most recent position estimate(s) for the RFID tag. If it receives multiple position estimates from a given RFID tag reader for a given RFID tag, the appliance 140 can select a preferred or best position estimate or compute the mean, median, and/or mode of the position estimate(s) for further reporting and/or processing. The appliance 140 also selects the maximum and minimum x and y values from among the current position estimates from all of the sensors and uses these values to compute the inter-sensor hypotenuse (InterSensorHyp) (260) according to Eq. (1).

The appliance 140 can use the hypotenuse or another measure of noise or dispersion in the current position estimates from the RFID tag readers 150 to select the winning position for the RFID tag, e.g., by discarding current position estimates that are too far away from an accepted or expected range of positions for the RFID tag (e.g., more than 2 meters or more one or two standard deviations away). The inter-sensor hypotenuse is a measure of the disagreement between sensors and/or of noise, whereas the intra-sensor hypotenuse is a measure of noise for a particular sensor. Generally, the intra-sensor hypotenuse can be used to prefer one sensor over another (the smaller the intra-sensor hypotenuse for a given sensor, the lower the noise in that sensor's measurements). A low inter-sensor hypotenuse among sensors indicates that the sensors' measurements are close to each other and can be averaged or otherwise combined for better performance. For instance, the appliance may receive measurements of the same tag from two, three, four, five, or more sensors, each of which computes its own intra-sensor hypotenuse or other measure of dispersion. The appliance picks the sensor(s) with the smallest intrasensor hypotenuse or other measure of dispersion as the best or preferred sensor(s). If forced to choose the best sensor(s) again, e.g., because of noise in the preferred position estimates, the appliance updates its selection based on recomputed intra-sensor hypotenuses or other measure(s) of dispersion and again selects the sensor(s) with the lower intra-sensor hypotenuse(s) or other measure(s) of dispersion, even if that sensor is the previously selected best or preferred sensor.

The appliance 140 can also use the intra- and inter-sensor hypotenuses or similar noise metrics to determine if an RFID tag reader's position estimates for a particular RFID tag should be disregarded. TABLE 1 (below) shows possible qualitative combinations of intra- and inter-sensor hypotenuses from two or more RFID tag readers. Low intra- and inter-sensor hypotenuses indicate that the RFID tag readers are making consistent position estimates that can be averaged or otherwise combined to reduce noise and/or increase confidence in the estimated position. If the intra-sensor hypotenuses are low and inter-sensor hypotenuse is high, then each RFID tag reader's measurements are consistent with its other measurements but not with measurements made by other RFID tag readers. This could indicate that one RFID tag reader's measurements are skewed or biased and should be discarded or disregarded. It could also mean that the RFID tag readers are reading different tags that have the same EPC, in which case the measurements may be accurate but cannot be reconciled or combined. It is very, very unlikely for two tags to have the same EPC—the tag registration process is supposed to prevent duplicate EPCs—but it can happen. Generally, if the inter-sensor hypotenuse is high, then the measurements from the noisier sensor (e.g., the sensor with the higher intra-sensor hypotenuse) should be discarded.

TABLE 1
Possible Qualitative Intra- and Inter-Sensor Hypotenuse Combinations

| Intra-Sensor | Inter-Sensor | | |
|---|---|---|---|
| Hypotenuse | Hypotenuse | Meaning | Commentary |
| Low | Low | Measurements from both RFID | Ideal |
| | | tag readers can be averaged or | |
| | | otherwise combined | |
| Low | High | Disagreement between RFID | Highly suspicious; possibly caused |
| | | tag readers; both RFID tag | by multipath or grating lobes |
| | | readers appear confident | |
| High | Low | Good agreement between | Good consistency but possibly |
| | | RFID tag readers; noisy ground | poor location; average position |
| | | plot | estimates from different sensors to |
| | | | improve performance |
| High | High | Higher uncertainty | Possibly self-consistent but not |
| | | | good for positioning or User |
| | | | Interface jump (i.e., the tag |
| | | | appears to jump among two or |
| | | | more widely separated locations) |

High intra-sensor hypotenuses and a low inter-sensor hypotenuse can indicate that the measurement environment is very noisy and that averaging the position estimates from all of the RFID tag readers may yield a more accurate position estimate for the RFID tag. If desired, the position estimates from different sensors can be weighted, e.g., based on the confidence in the measurements, before being combined or averaged. High intra- and inter-sensor hypotenuses may indicate that the tag is moving frequently or rapidly and/or that the environment is very noisy, for example, because other objects in the environment are causing time-varying multipath effects.

If the inter-sensor hypotenuse is too high (e.g., above a predetermined threshold based on the achievable measurement uncertainty, which may be tens to hundreds of centimeters), indicating that the RFID tag readers do not agree on the RFID tag's estimate position, then the central controller can pick position estimates from one RFID tag reader or one set of the RFID tag readers for reporting and further processing. In other words, the central controller picks a preferred or best RFID tag reader or set of RFID tag readers for measuring the location of that RFID tag. It uses the measurements from the preferred RFID tag reader or preferred set of RFID tag readers to compute and report the estimated position of an RFID tag and ignores or discards position estimates for the RFID tag from other RFID tag reader(s). Picking the best RFID tag reader or set of RFID tag readers for an RFID tag improves the precision of the system's estimate of the RFID tag's position. It can also increase the speed with which the system estimates the RFID tag's position by eliminating the need to perform or wait for and process measurements or position estimates from RFID tag readers that are not preferred, i.e., less likely to produce accurate results.

Generally, the central controller picks the RFID tag reader(s) with the lowest intra-sensor dispersion (e.g., hypotenuse, standard deviation, or variance) and enough position estimates as the best RFID tag reader(s) for a given RFID tag. For instance, the central controller can pick the RFID tag readers with intra-sensor hypotenuses below a predetermined threshold (e.g., 6 based on the achievable spatial resolution, which may be tens to hundreds of centimeters) and at least N measurements, where N is a positive integer (e.g., 2, 5, 10, 25, 50, or 100), to be preferred RFID tag readers for a given RFID tag.

The central controller can choose a preferred RFID tag reader or set of RFID tag readers for each RFID tag. An RFID tag reader may be (one of) the preferred RFID tag reader(s) for one RFID tag or set of RFID tags but not for other RFID tags. The nature of the communication channels in the environment may end up causing the preferred RFID tag readers for a given set of RFID tags to be the RFID tag readers closest to that set of RFID tags or with line-of-sight paths to that set of RFID tags. For example, the central controller may end up selecting, based on position estimates and intra-sensor hypotenuses, an RFID tag reader that has the shortest unobstructed path to a given RFID tag as a preferred RFID tag reader for that RFID tag.

The central controller can update the preferred RFID tag reader(s) for a given RFID tag if the dispersion of the position estimates for that RFID tag exceeds an acceptable limit or threshold. For example, the central controller may determine an updated hypotenuse every time it receives a new reply from or position estimate for that RFID tag. If the hypotenuse is within an acceptable limit, the central controller simply reports the position estimate and continues to process (only) tag replies and position estimates from the preferred RFID tag reader(s). (The central controller may continue to receive and store replies, position estimates, and other data for that RFID tag acquired by other sensors until that data becomes stale even if it reports position estimates from only the preferred RFID tag reader(s).) If the hypotenuse exceeds acceptable limits, the central controller may repeat its process of selecting the preferred sensor(s). In some cases, such as cases involving transient violations of the acceptable dispersion/hypotenuse limits, the central controller may end up picking the same preferred sensor(s) it chose before.

### State Machine Representation of an RFID Tag Location System

FIG. 3 illustrates a state machine representation 300 of an RFID tag location system or interrogator controller/appliance that selects preferred or best sensors for locating RFID tags. The appliance stores position estimates for each RFID tag, determines which sensor is the best, and reports position estimates from only from that sensor until it is determined that that sensor is no longer adequate. The state machine representation 300 can be for each sensor or for the appliance so long as the appliance can prune older data/measurements. The states include an initialization state 302, a wait or hold state 304, a data storage state 308, a data processing state 312, and a data pruning state 318. The system moves or cycles through the states in response to events, such as receiving replies from RFID tags. It starts in the initialization state 302 until it has completed initialization, at which point it transitions to a wait or hold state 304, where it stays until it receives a reply from an RFID tag. The detection of a reply indicates that a hop is complete (306), causing the RFID tag reader to transition to the data storage state 308. In the data storage state 308, the RFID tag reader dictates an update to a data structure that contains the position estimates, sensor that read the tag, and time at which the tag was read and is stored in memory based on the received reply. Once the reply data has been stored (310) in the data structure, the RFID tag reader enters the data processing state 312, in which it estimates the RFID tag's location and calculates the intra-sensor hypotenuse or other variance measure based on the detected replies. Once processing is complete (314), the RFID tag reader enters the data pruning state 316. In this data pruning state 316, the RFID tag reader removes data that is old, stale, outdated, and/or invalid from the data structure to prevent this data from skewing future location estimates. And once pruning is complete (318), the RFID tag reader returns to the wait state 304 until it receives new tag replies at the end of the next hop.

The RFID tag reader can cycle through the states in the state machine representation 300 on a per-hop basis, a periodic basis (e.g., every so many seconds or so many hops), or in response to other events. If cycling through the states on a periodic basis or in response to other events, the RFID tag reader accumulates data in the wait state 306 until the period has elapsed or the triggering event occurs before transitioning to the data storage state 308.

### Implementation of a “Best Sensor/Best Measurement”

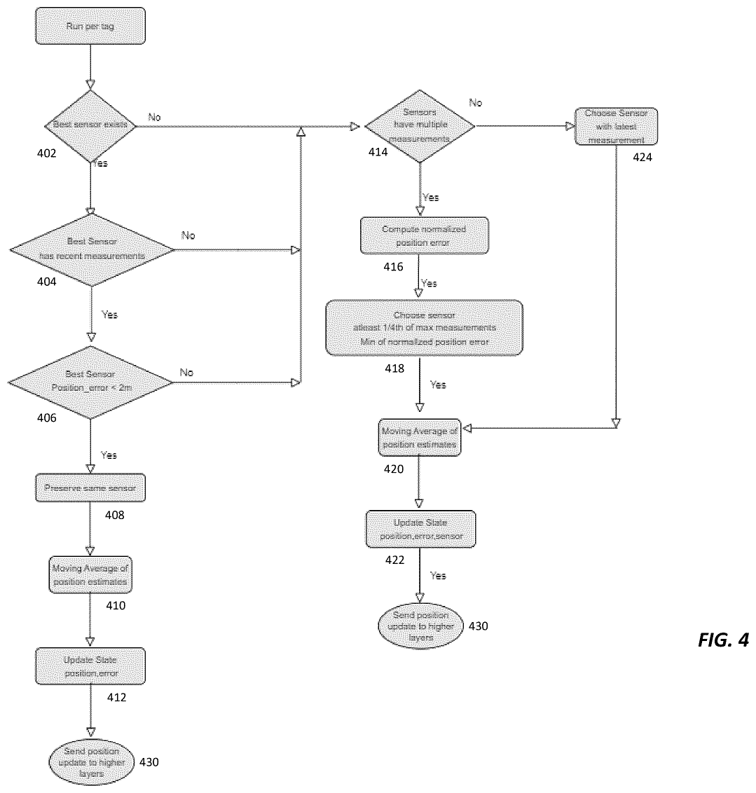

FIG. 4 illustrates a process for locating an RFID tag with an RFID sensing system using best sensor/best measurements. This RFID sensing system may perform this process separately for each RFID tag that it is trying to locate (400). The process starts with determining whether or not a “best sensor” exists for the RFID tag being located (402). If the RFID sensing system's appliance has already selected a “best sensor” for the tag, and that sensor has recent measurements of that tag (404), and the position error for those recent measurements is less than a threshold distance (e.g., <2 meters) (406), then the appliance does not change which sensor is the “best sensor” for that tag (408). Instead, it acquires a moving average of the best sensor's position estimates for that tag (410), updates the tag's state (including the tag's position and the associated positioning error) (412), and reports the position update to higher layer(s) of the RFID sensing system (430).

If no “best sensor” exists for the RFID tag being located (402), that sensor does not have recent measurements of that tag (404), or the position error for that sensor's recent measurements is greater than a threshold distance (e.g., >2 meters) (406), then the appliance selects a (new) best sensor for the tag. It does this by determining whether any sensors have multiple measurements of the tag being located (414). If so, then the appliance computes the normalized position error for the measurements by each sensor (416), then chooses the sensor with a minimum number of measurements below the corresponding normalized position error as the best sensor (418). For instance, the appliance can pick the sensor with the lowest normalized position error and with at least 25% of its position estimates below this error as the best sensor. If not, the appliance chooses the sensor with the most recent measurement of the tag as the best sensor (424). The appliance computes a moving average of the best sensor's position estimates (420), updates the tag's state (including the new best sensor), and reports the position update to higher layer(s) of the RFID sensing system (430).

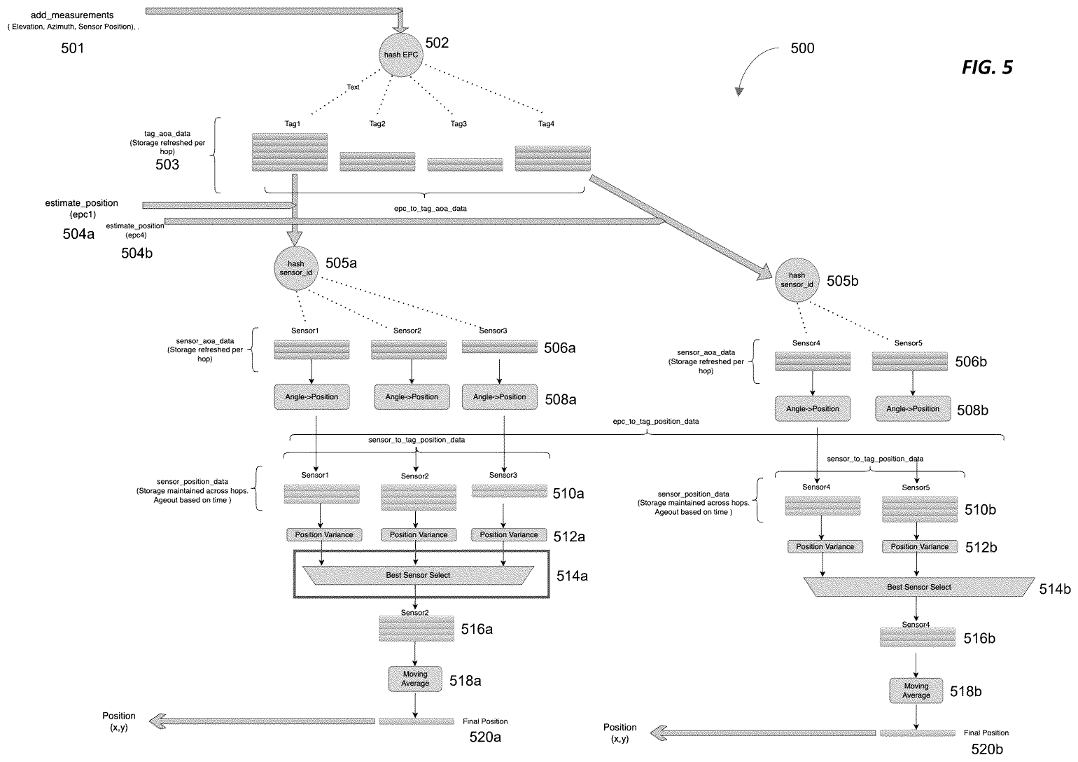

FIG. 5 illustrates one implementation of a process 500 for selecting the best sensor (here, Sensor1 through Sensor5) for each of several RFID tags (Tag1 through Tag4). This process 500 can be carried out by an appliance, for example, as steps 416 and 418 of the tag location process in FIG. 4. The RFID tag readers send information about themselves, including their positions; RFID tag data, including elevation and azimuth data (AOA data) derived from detected replies; and information about the RFID tags, such as the tags' EPCs, to the appliance (501). The appliance can hash the EPCs (502) for more efficient memory storage and retrieval, then sort or index this information (503) based on the associated EPCs (epc1 through epc4), each of which corresponds to a different RFID tag (e.g., epc1 for Tag1, epc2 for Tag2, and so on). (The appliance can look up tag and sensor data using hash tables based on the tag EPCs and sensor IDs, respectively.) The sensors and appliance can refresh the AOA data for each tag as often as every hop.

The appliance calculates a position estimate for at least one and possibly all of the RFID tags with respect to each RFID tag reader (sensor) that detects replies from that RFID tag and forwards AOA data for that RFID tag to the appliance. In FIG. 5, the appliance estimates positions for Tag1/epc1 (504a) and Tag4/epc4 (504b). The central controller hashes the sensor IDs (505a and 505b) for more efficient storage and retrieval, sorts the RFID tag data (and in particular the AOA data) by sensor (sensor_aoa_data; sensor_id) (506a, 506b), and estimates a position for each tag/sensor pair (sensor_to_tag_position_data) from the corresponding AOA data (508a, 508b). In FIG. 5, the appliance calculates position estimates (sensor_position_data) for Tag1 from AOA data acquired by Sensor1, Sensor2, and Sensor3 and for Tag4 from AOA data acquired by Sensor4 and Sensor5. For example, the appliance can calculate one position estimate per AOA measurement for each sensor—here, the appliance has three AOA measurements of Tag1 by Sensor1, three AOA measurements of Tag1 by Sensor2, and two AOA measurements of Tag1 by Sensor3, so it computes three position estimates for Tag1/Sensor1, three position estimates for Tag1/Sensor2, and two position estimates for Tag1/Sensor3. In other examples, a given RFID tag reader (e.g., Sensor2) may provide AOA data for more than one RFID tag (e.g., Tag1 and Tag2), in which case the central controller calculates position estimates for each RFID tag as measured by that RFID tag reader.

The appliance stores recent position estimates for each RFID tag (510a, 510b). It prunes old and/or invalid position estimates to prevent these measures from growing stale or becoming skewed as the RFID tags move, the environment changes, and/or averaging the AOA measurements reduces the effect of noise. The appliance uses the stored position estimates to calculate intra- and inter-sensor hypotenuses, position variances, or other measures of dispersion, noise, and/or (in)stability of the estimated positions for each RFID tag as described above (512a, 512b).

The appliance selects the best sensor for each tag based on the position variances for the sensors with position estimates for that tag (514a, 514b). Generally, the sensor selects the sensor with the lowest position variance for a given tag (e.g., the lowest hypotenuse or standard deviation) as the best sensor selected for that tag. In some cases, the appliance may select the best sensor based on multiple measures of position variance or dispersion, the number of (recent) measurements, a priori information about the tag's location or the RFID environment, and/or information derived from cameras or other sensors, etc. If more than one sensor meets the best sensor selection criterion or criteria for a given tag, then the appliance may select those sensors as the best sensors for that tag and average their position estimates. Once the appliance has selected the sensor or sensors that provide(s) the position estimate(s) most likely to be accurate (the “best” or “preferred” sensor(s)) for a given tag, the appliance aggregates position estimates for that tag by the best sensor (516a, 516b). In FIG. 5, the appliance selects Sensor2 as the best sensor for Tag1 and Sensor4 as the best sensor for Tag2. The appliance computes a running or moving average of the position estimates (518a, 518b), where the position estimates can be weighted by age, with newer position estimates weighted more heavily than older position estimates, from the best sensor(s). The appliance can compute this moving average over a predetermined or selectable time window or number of measurements (e.g., the last 30 seconds, one minute, five minutes, ten minutes, half hour, or hour or the last 10, 25, 50, 100, or 250 measurements). If the best sensor changes during this time window, the appliance can either continue the running average with position estimates from the new best sensor or reset the running average. If the appliance selects a set of sensors as the best sensors for a given tag, the appliance can aggregate and average (and optionally weight, based on the corresponding intra- and/or inter-sensor hypotenuses) the position estimates from those sensors to further improve the precision of the reported position estimate and report the aggregated or averaged position estimate. The appliance reports the moving averages as final position estimates to a user or other system that uses the position estimates (520a, 520b), e.g., an inventory management system that tracks the items to which the RFID tags are attached.

Using “Best Sensors” to Distinguish True from Spurious Position Estimates

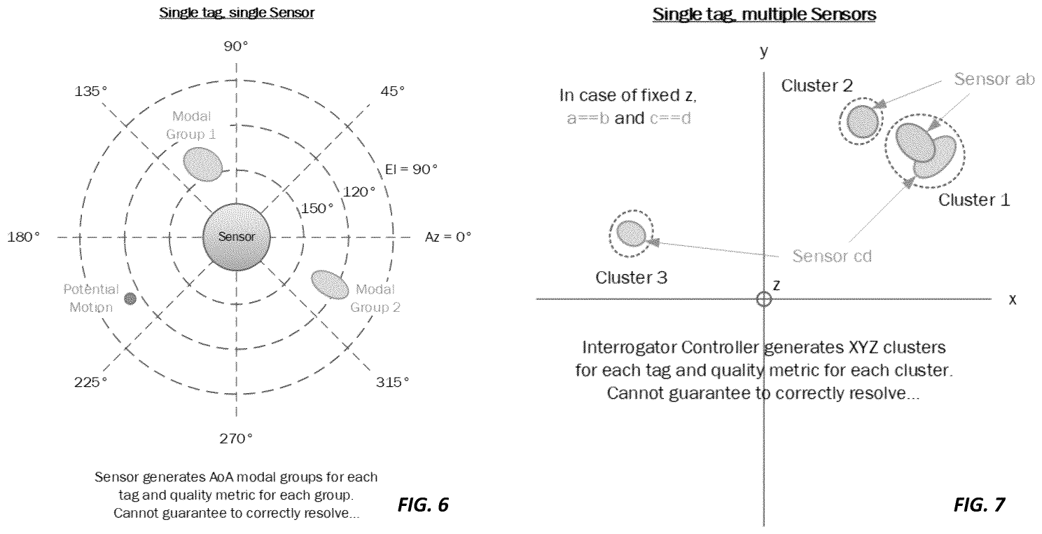

FIGS. 6-8 illustrate different scenarios in which one or more RFID tag readers generate multiple position estimates for a single RFID tag and how the “best sensor(s)” generate the position estimates that are most likely to be correct. If the position estimates are close enough to each other—for example, within a radius equal to the RFID tag system's spatial resolution then the appliance can average the position estimates to generate a more precise estimate of the tag's actual location. But if the position estimates are different enough—for example, separated by several times a predetermined error threshold—then the appliance may determine which position estimates are more likely to be correct and discard the others.

FIG. 6 is a polar plot of a single RFID tag reader's position estimates for a single RFID tag with the RFID tag reader (sensor) at the origin. Generally, an RFID tag reader's AOA measurement(s) for a given RFID tag vary over time due to changes in the communication channel between the RFID tag reader and the RFID tag or changes in the RFID tag's position. Changes in the communication channel may be caused by movement of people or other items in the environment (for example, a customer or sales associate moving other items on the rack or shelf that holds the item attached to the RFID tag). The changes in the communication channel cause the RFID tag reader's AOA measurements and hence the position estimate to vary over time. If the intra-sensor hypotenuse is low, the resulting position estimates may be close enough together to form a cluster or group.

Normally, an RFID tag reader's position estimates for a single tag form a single modal group. In a modal group, the position estimates are based on tag replies that encode the same EPC but are detected along different azimuths and/or different elevations. The position estimates in a single modal group can be averaged to reduce the effects of noise in the AOA measurements. In some cases, including the case shown in FIG. 6, the position estimates may form two or more distinct, widely separated modal groups. In these cases, it may not be possible to determine whether one modal group is more likely to be correct than the other modal group(s). If one modal group is closer to the tag's true position, it may not be possible to identify or estimate which modal group represents the RFID tag's true position without more information. This additional information can include the EPC of the RFID tag; the EPCs of other RFID tags in the environment; the layout of shelves, racks, and/or other fixtures in the environment; and/or position estimates of the RFID tag by other sensors. For instance, if the EPC of the RFID tag indicates that the tag is attached to a man's sweater, then the RFID tag reader or appliance can use group or cluster position estimates that place the RFID tag close to or on a fixture that holds or is supposed to hold other men's clothing or close to other RFID tags attached to men's sweaters.

FIG. 6 also shows a single position estimate marked as “potential motion.” This position estimate represents a change in the channel estimate that the central controller has attributed to movement of the RFID tag because the position estimate is far enough away from both modal groups for that RFID tag. In other words, the change in AOA of the tag's replies is so great that the RFID tag is assumed to have moved, at least transiently. For example, a person may have taken the RFID tag and associated item off a clothing rack, then put them back on the clothing rack. If the RFID tag reader queries the RFID tag as it moves along a trajectory or through a series of positions, the RFID tag reader should produce position estimates that follow that trajectory.

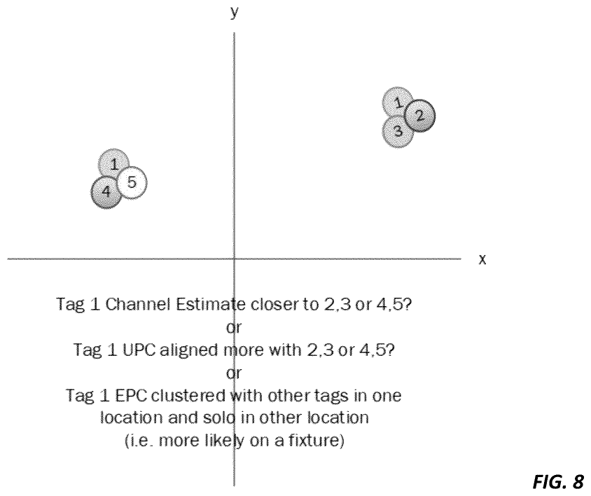

FIG. 7 is a plot, in Cartesian coordinates, of modal clusters of position estimates for a single RFID tag derived from AOA measurements by two RFID tag readers (sensors ab and cd). In this example, each RFID tag reader produces two modal clusters, each bordered by a solid line-sensor ab produces two clusters in the upper right quadrant of the plot, and sensor cd produces a cluster in the upper right quadrant and the upper left quadrant. The central controller aggregates these sensor clusters into super clusters, each bordered by a dashed line clusters 1 and 2 in the upper right quadrant, and cluster 3 in the upper left quadrant. The clusters may be grouped together based on a predetermined or dynamic error threshold, such as the uncertainty or resolution of the position estimates, using density-based spatial clustering of applications with noise (DBSCAN) or another suitable clustering technique.

In FIG. 7, with each RFID tag sensor reporting multiple modal groups for the RFID tag, the central controller may not be able to pick any “best sensor” or resolve the RFID tag's position correctly. At best, the central controller may estimate the RFID tag's position to be in the upper right quadrant, perhaps within or close to cluster 1, with an uncertainty based on the distribution of position estimates within cluster 1 and/or on the distribution of clusters. For example, the central controller may pick matching modal groups of bimodal distributions as the most probable tag position (e.g., those in cluster 1). It can also average corroborated measurements or pick one of the matching modal groups as the probable tag position.

If the central controller receives a single modal cluster of position estimates from another RFID tag reader that fits within cluster 1, then it may discard or ignore the position estimates in clusters 2 and 3. In other words, the central controller may select cluster 1 as the “best set” of sensor measurements. Alternatively, the central controller could determine that sensors ab and cd are not suitable “best sensors” and discard or ignore all of their measurements in favor of a sensor that produces only a single cluster of position estimates. Likewise, if sensor ab reported only the modal group in cluster 1, then the central controller could select cluster 1 as the “best set” of sensor measurements or select sensor ab as the “best sensor.”

Unfortunately, averaging the position estimates in different modal groups tends to produce an inaccurate or skewed position estimate. As a result, if an RFID tag reader produces many modal groups for a single RFID tag, then the central controller may discard or ignore all of the position estimates for that RFID tag from that RFID tag reader. Put differently, the central controller generally may not pick an RFID tag reader as a “best sensor” for an RFID tag if that RFID tag reader produces position estimates that form more than one modal group. Even if it does not use that RFID tag reader's position estimates to estimate the RFID tag's true position, the central controller can still use them to pick the “best sensors” by correlating the modal groups with modal or non-modal groups from other RFID tag readers.

FIG. 8 is a plot of location estimates for five different RFID tags (labeled 1-5). The shading for each location indicates the sensor that produced the location estimate: a first sensor produced two location estimates for tag 1, and four different sensors produced the location estimates for tags 2-5. In this case, the central controller selects the location estimate that is most likely to be correct for tag 1 by correlating other, independently obtained information about tag 1 with similar information about tags 2-5.

For example, the central controller can select the preferred or best location estimate based on the channel estimates for each tag/sensor pair if the channel estimates generally do not change much over short distances. Each channel estimate represents the attenuation, noise, interference, distortion, dispersion, etc. introduced into a signal as it propagates from a sensor to an RFID tag and back. Some of these effects are due to propagation through free space, whereas other effects are due to components in the channel, including filters, amplifiers, analog-to-digital converters (ADCs), antennas, and so on. If the channel is a filter, then the channel estimate can be thought of as the channel's transfer function.

The central controller can pick the “best” or most-likely-to-be-correct location estimate for tag 1 by comparing the channel estimates for the first sensor and tag 1 to the channel estimates for the other tag/sensor pairs. If the channel estimates are closest to the channel estimates for tags 4 and 5 and the first sensor is close the sensors that measured the location estimates for tags 4 and 5, for example, then the central controller picks the location estimate for tag 1 that is closest to the location estimates for tags 4 and 5.

The appliance can also use other information, including the EPCs for the tags, the Universal Product Codes (UPCs) for the items associated with or affixed to the tags, RSSIs, or variance to pick the “best” location estimate for tag 1. For example, the appliance can also select the location estimate for tag 1 that is closest to the location estimates for tags with similar EPCs or associated with similar UPCs. Similarly, if an inventory system or database shows that tags with particular EPCs or items with particular UPCs (e.g., men's pants) are expected to be near each other or near a particular location within the environment (e.g., on a fixture for men's pants), then the appliance may select the location estimate for tag 1 based on this information about the EPCs and/or UPCs. The appliance could even use the count, or number of position estimates in a cluster, with more measurements indicating a higher likelihood that the cluster is correct. These are just a few of the other pieces of information that a sensor can use to disambiguate multiple position estimates for the same tag.

### CONCLUSION

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain, using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the components so conjoined, i.e., components that are conjunctively present in some cases and disjunctively present in other cases. Multiple components listed with “and/or” should be construed in the same fashion, i.e., “one or more” of the components so conjoined. Other components may optionally be present other than the components specifically identified by the “and/of” clause, whether related or unrelated to those components specifically identified. Thus, as a non-limiting example, a reference to “A and/or B”, when used in conjunction with open-ended language such as “comprising” can refer, in one embodiment, to A only (optionally including components other than B); in another embodiment, to B only (optionally including components other than A); in yet another embodiment, to both A and B (optionally including other components); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of components, and, optionally, additional unlisted items. Only terms clearly indicated to the contrary, such as “only one of” or “exactly one of,” or, when used in the claims, “consisting of,” will refer to the inclusion of exactly one component of a number or list of components. In general, the term “or” as used herein shall only be interpreted as indicating exclusive alternatives (i.e., “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used herein in the specification and in the claims, the phrase “at least one,” in reference to a list of one or more components, should be understood to mean at least one component selected from any one or more of the components in the list of components, but not necessarily including at least one of each and every component specifically listed within the list of components and not excluding any combinations of components in the list of components. This definition also allows that components may optionally be present other than the components specifically identified within the list of components to which the phrase “at least one” refers, whether related or unrelated to those components specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including components other than B); in another embodiment, to at least one, optionally including more than one, B, with no A present (and optionally including components other than A); in yet another embodiment, to at least one, optionally including more than one, A, and at least one, optionally including more than one, B (and optionally including other components); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A method of locating a radio-frequency identification (RFID) tag, the method comprising:
at a first RFID tag reader in a plurality of RFID tag readers, detecting first replies from the RFID tag;
at a second RFID tag reader in a plurality of RFID tag readers, detecting second replies from the RFID tag;
determining, based on the first replies, a first set of possible positions of the RFID tag;
determining, based on the second replies, a second set of possible positions of the RFID tag;
determining a measure of dispersion of the first set of possible positions and a measure of dispersion of the second set of possible positions;
selecting, based at least in part on the measure of dispersion of the first set of possible positions and the measure of dispersion of the first set of possible positions, one of the first set of possible positions or the second set of possible positions as more precise than the other of the first set of possible positions or the second set of possible positions; and
determining, based on the one of the first set of possible positions or the second set of possible positions, an estimated position of the RFID tag.

2. The method of claim 1, wherein determining the first set of possible positions comprises:
determining respective angles of arrival at the first RFID tag reader for the first replies; and
estimating the first set of possible positions of the RFID tag based on the respective angles of arrival.

3. The method of claim 2, wherein determining the respective angles of arrival comprises:
filtering the respective angles of arrival based on elevation angle and/or distance between the RFID tag and the first RFID tag reader.

4. The method of claim 1, wherein determining the measure of dispersion of the first set of possible positions comprises computing at least one of a variance, a standard deviation, or a hypotenuse of a triangle defined by maximum x and y coordinates and minimum x and y coordinates among the possible positions in the first set of possible positions.

5. The method of claim 1, wherein selecting the one of the first set of possible positions or the second set of possible positions as more precise than the other of the first set of possible positions or the second set of possible positions comprises selecting the one of the first set of possible positions or the second set of possible positions with the lower measure of dispersion.

6. The method of claim 1, wherein determining the estimated position of the RFID tag comprises averaging the possible positions in the one of the first set of possible positions or the second set of possible positions.

7. A system for locating a radio-frequency identification (RFID) tag, the system comprising:
a first RFID tag reader to detect first replies from the RFID tag;
a second RFID tag reader to detect second replies from the RFID tag; and
an appliance, operably coupled to the first RFID tag reader and the second RFID tag reader, to:
determine, based on the first replies, a first set of possible positions of the RFID tag;
determine, based on the second replies, a second set of possible positions of the RFID tag;
determine a measure of dispersion of the first set of possible positions and a measure of dispersion of the second set of possible positions;
select, based at least in part on the measure of dispersion of the first set of possible positions and the measure of dispersion of the first set of possible positions, one of the first set of possible positions or the second set of possible positions as more precise than the other of the first set of possible positions or the second set of possible positions; and
determine, based on the one of the first set of possible positions or the second set of possible positions, an estimated position of the RFID tag.

8. The system of claim 7, wherein the appliance is configured to determine the first set of possible positions by:
determining respective angles of arrival at the first RFID tag reader for the first replies; and
estimating the first set of possible positions of the RFID tag based on the respective angles of arrival.

9. The system of claim 8, wherein the appliance is configured to determine the respective angles of arrival by:
filtering the respective angles of arrival based on elevation angle and/or distance between the RFID tag and the first RFID tag reader.

10. The system of claim 7, wherein the appliance is configured to determine the measure of dispersion of the first set of possible positions by computing at least one of a variance, a standard deviation, or a hypotenuse of a triangle defined by maximum x and y coordinates and minimum x and y coordinates among the possible positions in the first set of possible positions.

11. The system of claim 7, wherein the appliance is configured to select the one of the first set of possible positions or the second set of possible positions with the lower measure of dispersion as more precise than the other of the first set of possible positions or the second set of possible positions.

12. The system of claim 7, wherein the appliance is configured to determine the estimated position of the RFID tag comprises averaging the possible positions in the one of the first set of possible positions or the second set of possible positions.

13. A method of locating radio-frequency identification (RFID) tags with RFID tag readers, the method comprising:
at each RFID tag reader, detecting replies from each RFID tag; and
for each RFID tag,
determining, for each RFID tag reader, a set of position estimates for that RFID tag based on the replies detected from that RFID tag by that RFID tag reader,
determining respective measures of dispersion for the sets of position estimates;
selecting, based on the measures of dispersion, one of the RFID tag readers as a preferred RFID tag reader for that RFID tag; and
estimating a location of that RFID tag based only on replies detected by the preferred RFID tag reader for that RFID tag.

14. The method of claim 13, wherein determining the respective measures of dispersion comprises computing at least one of a variance, a standard deviation, or a hypotenuse of a triangle defined by maximum x and y coordinates and minimum x and y coordinates among the possible positions for each set of position estimates.

15. The method of claim 13, wherein selecting the one of the RFID tag readers as the preferred RFID tag reader comprises selecting the RFID tag reader with the lowest measure of dispersion for that RFID tag.

16. The method of claim 13, wherein selecting the one of the RFID tag readers as the preferred RFID tag reader comprises selecting a first RFID tag reader as the preferred RFID tag reader for a first RFID tag and selecting a second RFID tag reader other than the first RFID tag reader as the preferred RFID tag reader for a second RFID tag.

17. The method of claim 16, wherein selecting the one of the RFID tag readers as the preferred RFID tag reader further comprises selecting the first RFID tag reader as the preferred RFID tag reader for a third RFID tag.

18. The method of claim 13, further comprising, for at least one of the RFID tags:
detecting a change in the measure of dispersion of the set of position estimates for that RFID tag based on replies from that RFID tag detected by the preferred RFID tag reader; and
updating a selection of the preferred RFID tag reader for that RFID tag in response to the change in the measure of dispersion.

19. The method of claim 18, wherein updating the selection of the preferred RFID tag reader for that RFID tag comprises selecting a different one of the RFID tag readers as the preferred RFID tag reader.

20. The method of claim 18, wherein updating the selection of the preferred RFID tag reader for that RFID tag comprises selecting the same RFID tag reader as the preferred RFID tag reader.

21. An appliance for a radio-frequency identification (RFID) system, the appliance comprising:
an interface to receive measurements of RFID tags from RFID tag readers; and
a processor, operably coupled to the interface, to, for each RFID tag:
determine, for each RFID tag reader, a set of position estimates for that RFID tag based on the measurements of that RFID tag by that RFID tag reader,
determine respective measures of dispersion for the sets of position estimates;
select, based on the measures of dispersion, a first RFID tag reader of the RFID tag readers as a preferred RFID tag reader for that RFID tag; and
estimate the location of that RFID tag based only on replies detected by the preferred RFID tag reader for that RFID tag.

22. The appliance of claim 21, wherein the processor is configured to determine the respective measures of dispersion comprises computing at least one of a variance, a standard deviation, or a hypotenuse of a triangle defined by maximum x and y coordinates and minimum x and y coordinates among the possible positions for each set of position estimates.

23. The appliance of claim 21, wherein the processor is configured to select the RFID tag reader with the lowest measure of dispersion as the preferred RFID tag reader for that RFID tag.

24. The appliance of claim 21, wherein the processor is configured to select a second RFID tag reader other than the first RFID tag reader as the preferred RFID tag reader for a second RFID tag.

25. The appliance of claim 24, wherein the processor is configured to select the first RFID tag reader as the preferred RFID tag reader for a third RFID tag.

26. The appliance of claim 21, wherein the processor is further configured to, for at least one of the RFID tags:
detect a change in the measure of dispersion of the set of position estimates for that RFID tag based on replies from that RFID tag detected by the preferred RFID tag reader; and
update a selection of the preferred RFID tag reader for that RFID tag in response to the change in the measure of dispersion.

27. The appliance of claim 26, wherein the processor is configured to update the selection by selecting a different one of the RFID tag readers as the preferred RFID tag reader.

28. The appliance of claim 26, wherein the processor is configured to update the selection by selecting the same RFID tag reader as the preferred RFID tag reader.

29. A method of locating a radio-frequency identification (RFID) tag, the method comprising:
at each of a plurality of RFID tag readers, detecting a set of replies from the RFID tag;
determining, for the sets of replies, respective sets of estimated positions of the RFID tag;
determining respective variances of the sets of estimated positions of the RFID tag;
selecting the RFID tag reader from the plurality of RFID tag readers with the lowest variance as a preferred RFID tag reader for the RFID tag;
determining, based on the replies from the RFID tag detected by the preferred RFID tag reader, a final estimated position of the RFID tag; and
reporting the final estimated position of the RFID tag.

30. A system for locating a radio-frequency identification (RFID) tag, the system comprising:
plurality of RFID tag readers, each RFID tag configured to detect a set of replies from the RFID tag; and
an appliance, operably coupled to the plurality of RFID tag readers, to (i) determine respective sets of estimated positions of the RFID tag based on the sets of replies, (ii) determine respective variances of the sets of estimated positions of the RFID tag, (iii) select the RFID tag reader from the plurality of RFID tag readers with the lowest variance as a preferred RFID tag reader for the RFID tag, and (iv) determine, based on the replies from the RFID tag detected by the preferred RFID tag reader, a final estimated position of the RFID tag.
